(19) United States
(12) Patent Application Publication
(10) Pub. No.: US 2012/0250349 A1
(43) Pub. Date: Oct. 4, 2012

(54) LIGHT GUIDE MODULE AND TOUCH PANEL

(75) Inventors: Hsien-Wen CHANG, Miao-Li County (TW); Gjian DEN, Miao-Li County (TW)

(73) Assignees: CHIMEI INNOLUX CORPORATION, Miao-Li County (TW); INNOCOM TECHNOLOGY(SHENZHEN) CO., LTD., Longhua Town (CN)

(21) Appl. No.: 13/426,093

(22) Filed: Mar. 21, 2012

(30) Foreign Application Priority Data
Mar. 28, 2011 (TW) 100110557

(51) Int. Cl. F21V 8/00

(52) U.S. Cl. 362/602; 362/621

(57) ABSTRACT

A light guide module is provided. The light guide module includes a light guide strip, a light transmitting plate, and a microstructure unit. The light guide strip includes a light incident surface, a first lateral surface, and an intense region, wherein the first lateral surface is adjacent to the light incident surface and the intense region is defined in a region of the light guide strip which is close to the light incident surface. The light transmitting plate faces the first lateral surface of the light guide strip. The microstructure unit is disposed at the light transmitting plate corresponding to the intense region.

### CROSS REFERENCE TO RELATED APPLICATIONS

This Application claims priority of Taiwan Patent Application No. 100110557, filed on Mar. 28, 2011, the entirety of which is incorporated by reference herein.

### BACKGROUND

1. Field of the Invention

The present disclosure relates to a light guide module, and in particular relates to a light guide module including microstructures.

2. Description of the Related Art

Conventionally, a touch panel is provided with pressure sensitive type sensors or capacitance type sensors on an entire panel surface and when the panel surface is touched with a fingertip, the sensors detect the position of the fingertip. However, such touch panel requires mounting a large number of sensors on the entire panel surface, which makes manufacturing of the touch panel difficult.

An optical type touch panel is known for not having the above-mentioned problems, as light emitting elements and light receiving elements are disposed on the periphery of the panel. When a finger touches the panel surface, light emitted from the light emitting element is interrupted and hence the light received by the light receiving element is reduced. Thus, a touched position may be detected.

For the optical type touch panel, light must be dispersed evenly on a surface of the panel, so that the touched position can be detected precisely. Unfortunately, compared with other areas of the panel, areas near the light emitting elements of the panel, possess larger light energy, which prevents the light receiving element from detecting touched positions thereat, precisely.

In U.S. Pat. No. 5,363,294, a light source device having a light guide plate is disclosed. By changing a density of dots printed on the bottom surface of the light guide plate, luminous intensity of areas near a light emitting side of the light source device is reduced. While this technique is prominent as applying to the light guide plate, for a light guide strip which has less width in dimension than that of the light guide plate, the above mentioned problems are still existed. Thus, a method for overcoming the above described deficiencies is needed.

### SUMMARY

The disclosure provides a light guide module. The light guide module includes a light guide strip, a light transmitting plate, and a microstructure unit. The light guide strip includes a light incident surface, a first lateral surface, and an intense region, wherein the first lateral surface is adjacent to the light incident surface and the intense region is defined in a region of the light guide strip which is close to the light incident surface. The light transmitting plate faces the first lateral surface of the light guide strip. Corresponding to the intense region, the microstructure unit is disposed on the surface of the light transmitting plate.

The disclosure further provides a touch panel. The touch panel includes a main body, a plurality of light guide modules, a plurality of light emitting elements, and a plurality of light receiving devices. The light guide modules are disposed at the lateral side of the main body, and each of the light guide modules includes a light guide strip, a light transmitting plate, and a microstructure unit. The light guide strip includes a light incident surface, a first lateral surface, and an intense region, wherein the first lateral surface is adjacent to the light incident surface and the intense region is defined in a region of the light guide strip which is close to the light incident surface. The light transmitting plate faces the first lateral surface of the light guide strip. Corresponding to the intense region, the microstructure unit is disposed on the surface of the light transmitting plate. The light emitting elements are disposed correspondingly to the light guide modules separately, and the light receiving devices are disposed between each two neighboring light guide modules.

By means of the microstructure unit of the light guide modules, light can be dispersed evenly on a surface of a touch panel, so that a touched position can be detected precisely by the touch panel.

### BRIEF DESCRIPTION OF THE DRAWINGS

The present disclosure can be more fully understood by reading the subsequent detailed description and examples with references made to the accompanying drawings, wherein:

FIGS. 1A-1B are explosive views of a light guide module of a embodiment of the invention;

FIG. 2 shows a side view of the light guide module seen along an A direction in FIG. 1A;

FIGS. 3A-3B show schematic views of microstructure units of the other embodiment of the invention;

FIG. 4 is an explanatory drawing showing a light field in a light guide module of a embodiment of the invention; and

FIG. 5 shows a schematic view of a touch panel utilizing light guide modules of an embodiment of the invention.

### DETAILED DESCRIPTION

The following description is one of the embodiments of the invention. This description is made for the purpose of illustrating the general principles of the invention and should not be taken in a limiting sense. The scope of the invention is best determined by reference to the appended claims.

In order to improve the precision of detection of a optical type touch panel, the disclosure provides a light guide module allowing light emitted from a light emitting element to be dispersed evenly on a surface of a touch panel, so as to overcome problems in the prior art where light energy is concentrated in a vicinity of a light emitting element.

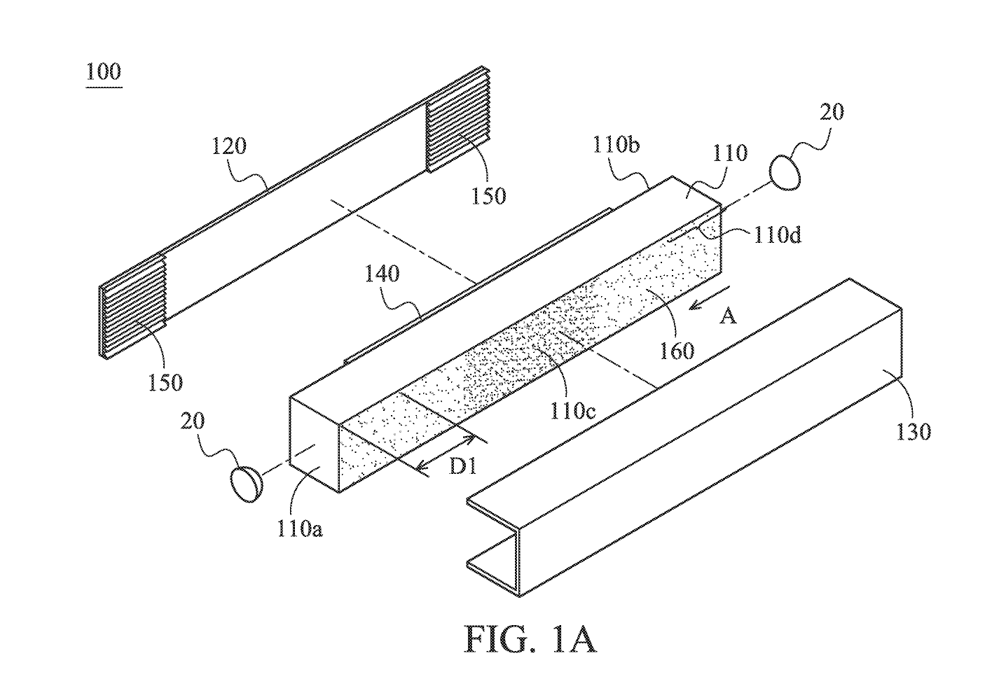

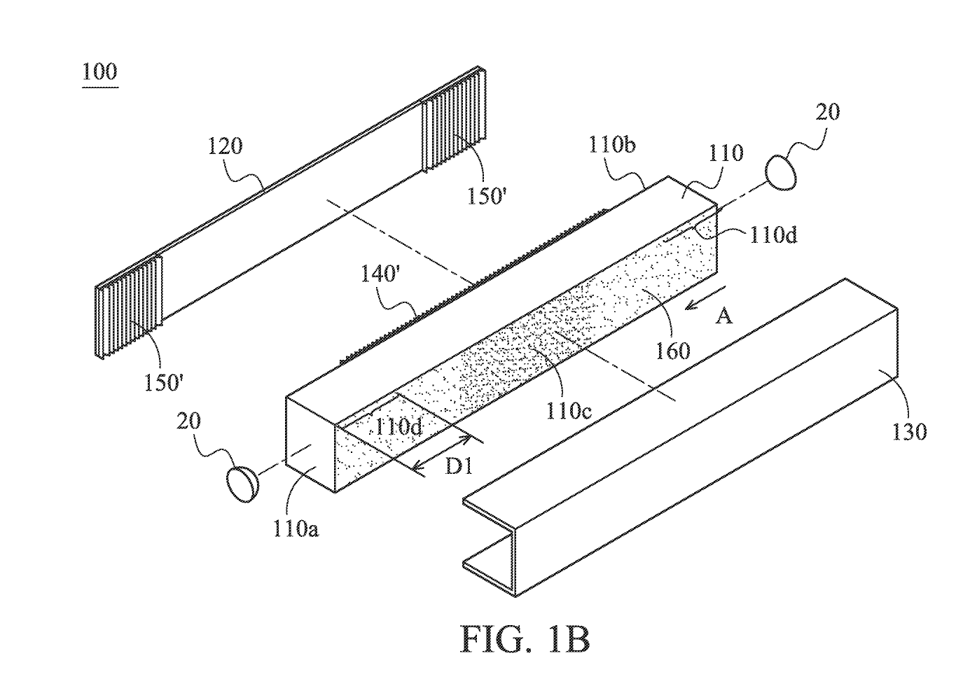

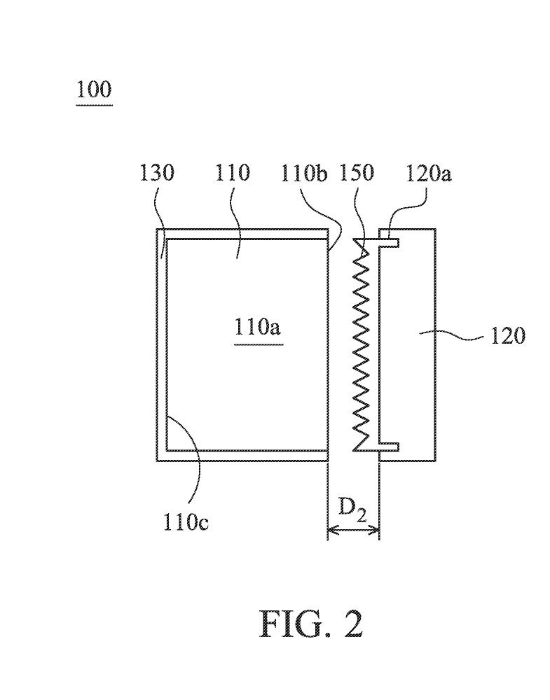

Please refer to FIGS. 1A, 1B and 2, which show the light guide module 100 of the disclosure, wherein in FIG. 2, a side view of the light guide module 100 seen along an A direction in FIG. 1A is shown, and for illustration purposes, a brightness enhancement film 140 is not illustrated in FIG. 2. In an embodiment of the invention, the light guide module 100 includes a light guide strip 110, a light transmitting plate 120, a reflective layer 130, a brightness enhancement film 140, two microstructure units 150, and at least one light emitting element 20.

The light guide strip 110 includes two light incident surfaces 110a, a first lateral surface 110b, a second lateral surface 110c, and two intense regions 110d. The two light emitting elements 20 are adjacent to the light incident surfaces 110a of the light guide strip 110, and the light incident surfaces 110a of the light guide strip 110 receive light from the light emitting elements 20. The first lateral surface 110b is adjacent to the light incident surfaces 110a, and the second lateral surface 110c is opposite to the first lateral surface 110b. The intense regions 110d of the light guide strip 110 are defined in particular regions of the light guide strip 110, between the light incident surfaces 110a and a predetermined position, wherein the predetermined positions are away from the light incident surfaces 110a by a distance D1 equal to 5-20 mm. The predetermined positions can be away from the light incident surfaces 110a by a distance D1 equal to 10 mm.

The thickness, material, and structural form of the light guide strip 110 of the disclosure can be modified according to a particular demand. In this embodiment, because the light guide strip 110 is disposed at a lateral side of a touch panel (shown in FIG. 5 and will be described in detail later), the thickness of the light guides strip 110 can be 1.5 mm. Furthermore, to allow light coursing in the light guide strip 110, the light guide strip 110 is made of a material which has a reflective index greater than that of air, such as glass. In addition, in this embodiment, the light guide strip 110 has a rectangular cross section.

One of the surfaces of the light transmitting plate 120 faces the first lateral surface 110b of the light guide strip 110 and is separated from the first lateral surface 110b. A distance between the surface of the light transmitting plate 120 and the first lateral surface 110b of the light guide strip 110 can be equal to 0.01 mm to 0.56 mm. The light transmitting plate 120 is made of a light-transmitting material, and the reflective index of the light transmitting plate 120 is between 1.48 and 1.62.

To destroy the phenomenon of total reflection of the light beams in the light guide strip 110, the reflective layer 130 is disposed on the second lateral surface 110c of the light guide strip 110. Specifically, in this embodiment, the reflective layer 130 is disposed on the second lateral surface 110c of the light guide strip 110, and two sides of the light guide strip 110 which are adjacent to the light incident surfaces 110a, the first lateral surface 110b and the second lateral surface 110c. The reflective layer 130 has a square U-shape, and the light guide strip 110 is received in the reflective layer 130.

A plurality of V-shaped grooves are formed side by side at a surface of the brightness enhancement film 140. In this embodiment, corresponding to a region of the light guide strip 110 which is beyond the intense regions 110d, the brightness enhancement film 140 is disposed at the first lateral surface 110b of the light guide strip 110, so as to enhance emission luminance of the region beyond the intense regions 110d of the light guide strip 110.

The microstructure units 150 respectively include a plurality of concave and convex structures configured to modify an incident angle of light. In this embodiment, the microstructure units 150 are brightness enhancement films, including a plurality of V-shaped grooves formed on a surface of each of the brightness enhancement films 150. Through the recesses 120a of the light transmitting plate 120, the microstructure units 150 are fixed at the surface of the light transmitting plate 120.

It is noted that the brightness enhancement film 140 is independent from the brightness enhancement films 150. The brightness enhancement films 150 are disposed on the surface of the light transmitting plate 120, and the V-shaped grooves of the brightness enhancement films 150 face the intense regions 110d of the light guide strip 110. On the contrary, the brightness enhancement film 140 is disposed on the first lateral surface 110b of the light guide strip 110, and the V-shaped grooves of the brightness enhancement film 140 face the light transmitting plate 120.

In an embodiment, as shown in FIG. 1A, the V-shaped grooves of the brightness enhancement film 140 and the brightness enhancement films 150 are extended in a direction parallel to an extending direction of the light guide strip 110, but it should not be limited thereto. As shown in FIG. 1B, the V-shaped grooves of the brightness enhancement film 140′ and the brightness enhancement films 150′ are extended in a direction perpendicular to the extending direction of the light guide strip 110. Alternatively, the V-shaped grooves of the brightness enhancement film 140 and the brightness enhancement films 150 are respectively arranged at different angles, not shown in the figure.

A plurality of dots 160 are printed on the second lateral surface 110c of the light guide strip 110. In a region relative to the intense region 110d of the light guide strip 110, the dots 160 can be printed sparsely, and in a region beyond the intense region 110d of the light guide strip 110, the dots 160 can be printed densely.

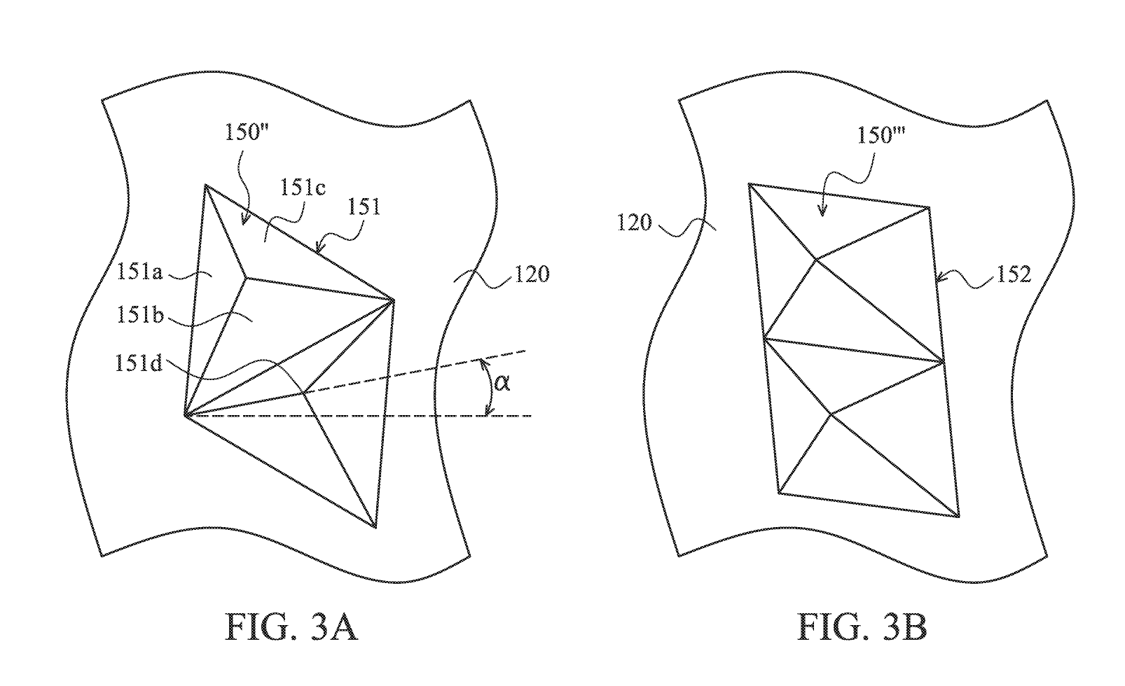

Please refer to FIGS. 3A and 3B. FIGS. 3A and 3B respectively show a schematic view of partial structures of microstructure units 150″ and 150′″ of other embodiments of the invention, wherein only a portion of the pyramids of the microstructure units are illustrated. In these embodiments, the microstructure units 150″ and 150′″ are directly formed at the surface of the light transmitting plate 120 by injection molding technology. That is, the microstructure units 150″ and 150′″ and the light transmitting plate 120 are integrally formed.

The microstructure units 150″ and 150′″ can be composed of various structural forms. For example, as shown in FIG. 3A, the microstructure unit 150″ is composed of a plurality of triangular pyramids 151, wherein an angle α, formed between the surface of the light transmitting plate 120 and a connecting line that connects an apex of each base of the triangular pyramids 151 to an apex 151d of each top of the triangular pyramids 151, is equal to 5-26 degrees. To increase reflection, the three side surfaces 151a, 151b, and 151c of the triangular pyramids 151 are nonisometric. In a further example, as shown in FIG. 3B, the microstructure unit 150′″ is composed of a plurality of quadrangular pyramids 152. The structural forms of the microstructure unit should not be limited. Any microstructure allowing light to transmit and reflect simultaneously can be the microstructure unit of the disclosure.

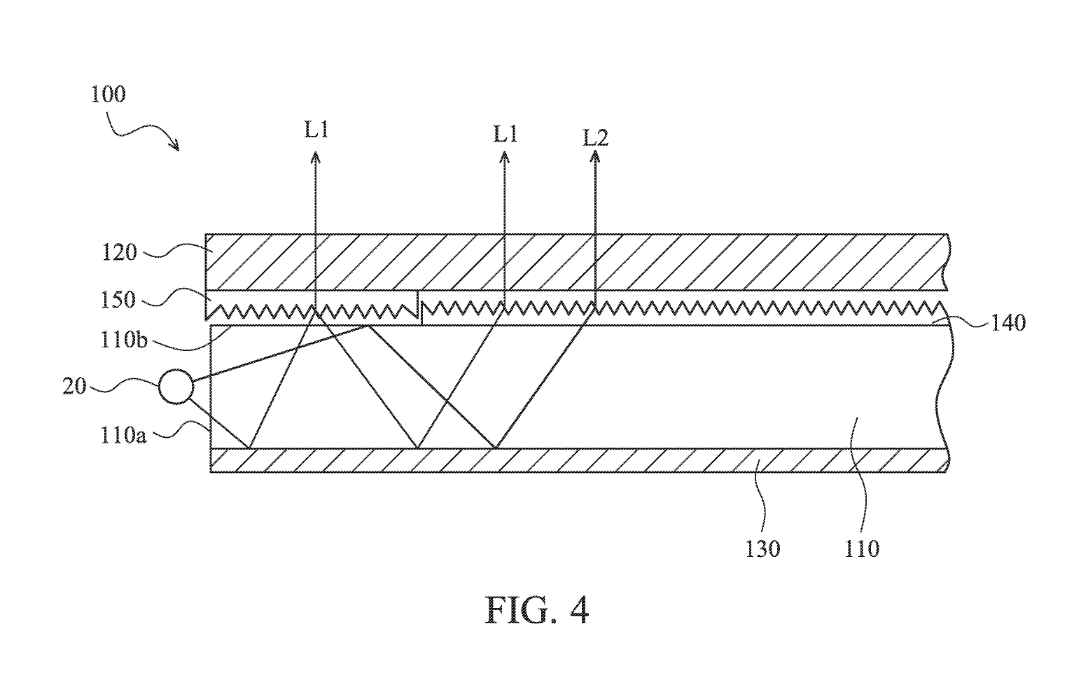

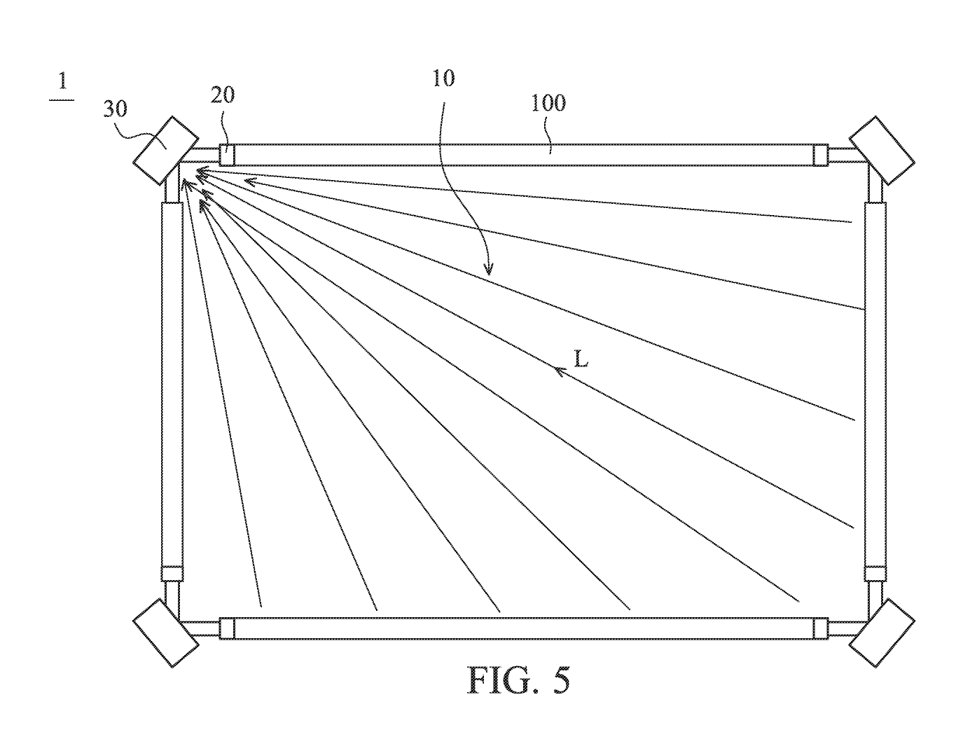

Please refer to FIG. 4. FIG. 4 is an explanatory drawing showing a light field in a light guide module 100 of the disclosure. For illustration purposes, only two infrared lights L1 and L2 are depicted in FIG. 4. After an infrared light L1 emitted by the light emitting element 20 toward the light guide module 100 passes through the light incident surface 110a of the light guide strip 110, the infrared light L1 is reflected by the reflective layer 130. And then the infrared light L1 impinges on the first lateral surface 110b, and due to the change of an incident angle of light the infrared light L1 can leave the light guide strip 110 and strike the microstructure unit 150. At this time, a portion of the infrared light L1 passes through the microstructure unit 150 and the light transmitting plate 120 and leaves the light guide module 100. The other portion of the infrared light L1 is reflected by the microstructure unit 150 and once again incidents into the light guide strip 110. The infrared light L1 reflected into the light guide strip 110 is reflected by the reflective layer 130 again, and the infrared light L1 passes through the first lateral surface 110b of the light guide strip 110 which has a brightness enhancement film 140 disposed thereon and impinges into the brightness enhancement film 140. After concentrated by the brightness enhancement film 140, the infrared light L1 passes through the light transmitting plate 120 and leaves the light guide module 100.

On the other hand, total reflection occurs at the first lateral surface 110b of the light guide strip 110 as the infrared light L2 enters the light guide strip 110, and then the infrared light L2 is reflected by the reflective layer 130. Due to a change of an incident angle of light, the infrared light L2 is permitted to pass through the first lateral surface 110b of the light guide strip 110. After concentrated by the brightness enhancement film 140, the infrared light L2 passes through the light transmitting plate 120 and leaves the light guide module 100.

Please refer to FIG. 5. FIG. 5 shows a schematic view of a touch panel 1 utilizing light guide modules 100 of the disclosure. The touch panel 1 includes a main body 10, a plurality of light emitting elements 20, four light receiving devices 30, and four light guide modules 100. The four light receiving devices 30 are respectively disposed at four corners of the main body 10, and the four light guide modules 100 are respectively disposed at four sides of the main body 10, so that the light receiving devices 30 are disposed between each two neighboring light guide modules 100. The light guide modules 100 disposed on two long sides of the main body 10 have two light emitting elements 20 which are disposed at two opposite sides of the light guide modules 100. The light guide modules 100 disposed on two short sides of the main body 10 have one light emitting element 20 which is disposed at one side of the light guide modules 100. Through the light guide modules 100, infrared light L emitted by the light emitting elements 20 are dispersed evenly on an area encircled by the light guide modules 100. When a user touches the central area of the touch panel 1, the four light receiving devices 30 simultaneously detect a reduction of the infrared light L and transmit detection results to an analyst device to analyze a touched position.

As reflected above, according to the light guide module disclosed in the invention, the light(s) emitted by the light emitting element(s) is guided to regions of the light guide strip which are distant from the light incident surface(s). Therefore, the problem in the prior art where light energy is concentrated at a vicinity of a light emitting element of a touch panel is overcome.

While the invention has been described by way of example and in terms of embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light guide module, comprising:
a light guide strip, comprising a light incident surface, a first lateral surface, and an intense region, wherein the first lateral surface is adjacent to the light incident surface and the intense region is defined in a region of the light guide strip which is close to the light incident surface;
a light transmitting plate, facing the first lateral surface of the light guide strip; and
a microstructure unit, corresponding to the intense region, disposed at the light transmitting plate.

2. The light guide module as claimed in claim 1, wherein the intense region is defined in a region of the light guide strip, between the light incident surface and a predetermined position, wherein the distance from the predetermined position to the light incident surface is equal to 5-20 mm.

3. The light guide module as claimed in claim 2, wherein the distance from the predetermined position to the light incident surface is equal to 10 mm.

4. The light guide module as claimed in claim 2, further comprising a brightness enhancement film, wherein, the brightness enhancement film is disposed at a region beyond the intense region of the first lateral surface of the light guide strip.

5. The light guide module as claimed in claim 1, further comprising a square U-shape reflective layer, wherein the light guide strip further comprises a second lateral surface opposite to the first lateral surface, and the square U-shape reflective layer is disposed on the second lateral surface.

6. The light guide module as claimed in claim 1, wherein the light transmitting plate comprises a reflective index between 1.48 and 1.62.

7. The light guide module as claimed in claim 1, wherein the light transmitting plate is separated from the first lateral surface of the light guide strip by a distance of 0.01-0.56 mm.

8. The light guide module as claimed in claim 1, wherein the microstructure unit comprises a plurality of triangular pyramids, and the triangular pyramids are disposed at a surface of the light transmitting plate.

9. The light guide module as claimed in claim 8, wherein an angle, formed between the surface of the light transmitting plate and a connecting line that connects an apex of each base of the triangular pyramids to an apex of each top of the triangular pyramids, is equal to 5-26 degrees.

10. The light guide module as claimed in claim 1, wherein the microstructure unit comprises a plurality of quadrangular pyramids, and the quadrangular pyramids are disposed at a surface of the light transmitting plate.

11. The light guide module as claimed in claim 1, wherein the microstructure unit comprises a brightness enhancement film comprising a plurality of grooves formed side by side on a surface of the brightness enhancement film, wherein the grooves extend in a direction parallel to an extending direction of the light guide strip.

12. The light guide module as claimed in claim 1, wherein the microstructure unit comprises a brightness enhancement film comprising a plurality of grooves formed side by side on a surface of the brightness enhancement film, wherein the grooves extend in a direction perpendicular to an extending direction of the light guide strip.

13. A touch panel, comprising:
a main body;
a plurality of light guide modules, disposed at lateral surfaces of the main
a light guide strip, comprising a light incident surface, a first lateral surface, and a intense region, wherein the first lateral surface is adjacent to the light incident surface and the intense region is defined in a region of the light guide strip which is adjacent to the light incident surface;
a light transmitting plate, facing the first lateral surface of the light guide strip; and
a microstructure unit, corresponding to the intense region, disposed at the light transmitting plate;
a plurality of light emitting elements, disposed correspondingly to the light guide modules respectively; and
a plurality of light receiving devices, disposed between each two neighboring light guide modules.

14. The touch panel as claimed in claim 13, wherein at least one of the light emitting elements is adjacent to the light incident surface of the light guide strip.

15. The touch panel as claimed in claim 14, wherein the microstructure unit comprises a concave and convex structure configured to change an incident angle of a light emitting from the light emitting elements.
